(19) United States
(12) Patent Application Publication
(10) Pub. No.: US 2002/0092861 A1
(43) Pub. Date: Jul. 18, 2002

(54) Magazine vending machine

(76) Inventors: Harry J. Zerwig, Union, MO (US); Gary N. Birk, Creve Coeur, MO (US); David W. Duncan, Chesterfield, MO (US); Leonard A. Ficken, Manchester, MO (US); Paul K. Griner, St. Louis, MO (US); Gregory S. Ivey, O' Fallon, MO (US); Charles W. Percy, Chesterfield, MO (US); Frank L. Walter, Maryland Heights, MO (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/759,975

(22) Filed: Jan. 12, 2001

(51) Int. Cl. B65H 3/00; B65G 59/00; G07F 11/46

(52) U.S. Cl. 221/126; 221/133; 221/155; 221/195; 221/232

(57) ABSTRACT

A magazine vending machine provides a plurality of vending mechanisms in a series of rows and columns in a glass front cabinet. Each vending mechanism includes a magazine dispensing mechanism for individually dispensing customer selected magazines and a pusher plate assembly that can be locked in a rear most loading position to allow the operator to fill each vending mechanism with magazines. The magazine dispensing mechanism includes a microprocessor and sensor arrangement which determines the height of magazine dispensed from the magazine vending mechanism and makes adjustments to the magazine dispensing mechanism operation according to the height of the magazine.

### BACKGROUND OF THE INVENTION

1. Field of the Invention

The present invention relates to vending machines and more particularly to a vending machine for vending magazine and the like including mechanisms to assist in loading and dispensing products, such as magazines, from such vending machines.

2. Description of the Prior Art

Many known vending machines for newspapers, magazines or similar articles utilize a storage and delivery system in which such articles are stored in one or more horizontal stacks and dispensed one at a time from the top of a stack with a mechanism that frictionally engages the top surface of the article on the top of the stack and moves it to a dispensing chute or opening in the machine where it can be retrieved by a customer. Such a vending machine is shown for example in U.S. Pat. No. 5,516,003.

Other known types of vending machines for vending articles such as newspapers or magazines store them in vertical stacks with their bottom edges supported by a horizontal shelf and use a pusher plate positioned at the rear of the stack which moves the entire stack forward on the horizontal surface so that a forward most article in the stack is moved into a dispensing chute. Such a vending machine is shown for example in U.S. Pat. No. 5,199,599.

All of these prior art machines are difficult to load or reload with newspapers and magazines, requiring substantial skill and training of personnel for that purpose. Such machines also have complex dispensing mechanisms to adjust for changes in thickness of newspapers or magazines loaded into a particular dispensing mechanism. These mechanisms make the dispensers difficult for the service personnel to load and adjust.

### SUMMARY OF THE INVENTION

The present invention overcomes the above described difficulties and disadvantages of the prior art newspaper, magazine or similar article stacking and dispensing devices by providing such a device that is easy to load with a stack of newspapers, magazines or similar articles and efficiently vends the articles selected by a customer.

These advantages are provided by a magazine vending machine, having a cabinet with a substantial portion of a front panel thereof transparent; a monetary section for establishing credit in the machine; a selection panel for allowing a customer to make a selection of a magazine from the machine once adequate credit is established; a plurality of magazine vending mechanisms mounted within the cabinet and viewable through the transparent portion of the front panel; each vending mechanism including a magazine support surface engagable by an edge of a magazine so as to support the magazine to be vended from the vending mechanism; a pusher plate movable between a position adjacent to the transparent portion of the front panel and a position remote from the transparent portion of the front panel and engagable with a back cover of the magazine so as to move the magazine along the support surface; a magazine dispensing mechanism disposed at a front edge of the magazine support surface and having at least one motor driven friction wheel engagable with a front cover of a magazine disposed at the front edge of the magazine support surface for vending a magazine from the vending mechanism; and a vend bucket mounted within the cabinet beneath the plurality of magazine vending mechanisms so as to receive a magazine vended from any of the magazine vending mechanisms and accessible by a customer to remove the vended magazine.

Such a vending machine also preferably includes a mechanism engaging the pusher plate for biasing the pusher plate toward the front panel. Such a machine also preferably includes the mechanism engaging the pusher plate including a scissor mechanism engaging the pusher plate and biased by at least one spring so as to bias the movement of the pusher plate toward the front panel. In addition, such a machine also preferably includes the pusher plate being tilted rearwardly from vertical so as to display a magazine engaged by the pusher plate at a rearward angle from the vertical.

Such a magazine vending machine also preferably includes a magazine retention member disposed above the front edge of the magazine support surface and engagable with an upper portion of the front cover of a magazine when disposed at the front edge of the support surface. In addition, it also preferably includes the magazine retention member being mounted to the magazine vending mechanism for movement between a first position where it will engage the front cover of a magazine disposed at the front edge of the support surface and a second position remote therefrom such that a magazine can be loaded into the vending mechanism without engaging the retention member. Preferably, the retention member is pivotally mounted to a rear portion of the vending mechanism so as to be movable between the first and second positions and a member is preferably mounted to the pusher plate and engagable with the retention member when the pusher plate is moved toward its position remote from the front panel so as to move the retention member to its second position.

In its preferred form the magazine vending machine includes a locking mechanism associated with the pusher plate for releasably holding the pusher plate in the position remote from the front panel. The locking mechanism preferably includes a push rod connected at one end to the pusher plate and an opposite end engagable with the locking mechanism; the locking mechanism including a “push-push” type locking mechanism. This “push-push” locking mechanism preferably includes a cam follower connected to the push rod and having a cam engaging portion; a locking cam member having an inlet and an outlet on a front side thereof and camming grooves in a top surface thereof having a generally heart-shaped configuration stepped at different levels from the inlet to the outlet so as to provide a one-way path for the cam follower through the cam member, including an intermediate locking position; and a spring member urging the cam follower in a direction out of the inlet and outlet of the locking member. The inlet of the locking member also preferably includes side walls which channel the cam follower into the camming grooves, the camming grooves including an upwardly inclined ramp extending from the inlet to a remote end terminating in a first step below the end of the ramp and extending in a direction away from the inlet, a second step extending downwardly from the first step in a direction toward the outlet and forming a locking position in which the cam follower will remain unless the spring force is overcome, a third step extending downwardly from the second step in a direction away from the inlet and a fourth step extending toward the outlet including an upwardly inclined portion terminating in the outlet.

The magazine dispensing mechanism of the vending machine preferably includes the motor being mounted in a rear portion of the magazine dispensing mechanism; the friction wheel being mounted on a rotatable shaft mounted in the front portion of the vending mechanism; and an endless belt driven by the motor and engaging the shaft for rotating the friction wheels. The dispensing mechanism also preferably includes a lever and microswitch arrangement such that the lever is engagable with the front cover of a magazine for sensing when the upper edge of a magazine being dispensed passes the lever; means associated with the motor for operating the motor to rotate the friction wheels in response to a vend signal initiated by a customer to feed a magazine off of the front edge of the magazine support surface, the means including stepping the motor in small increments near the top of the magazine until the microswitch indicates that the top of the magazine has passed the lever and then stopping the motor and maintaining in a memory the height of the magazine so that the next operation steps the motor for a lesser number of steps nearer the top of the magazine.

The magazine vending machine also preferably includes an adjustable magazine thickness gauge disposed at the front edge of the magazine support surface and slidably supported beneath the surface for movement toward and away from the magazine dispensing mechanism so as to engage the back cover of a magazine when the front cover is engaged by the dispensing mechanism, the gauge preventing a second magazine adjacent the magazine being dispensed from also being dispensed.

The magazine vending machine also preferably includes a magazine deflector plate disposed at the front of a first magazine dispensing mechanism so as to deflect a magazine dispensed from a second magazine dispensing mechanism disposed above the first magazine dispensing mechanism.

Other objects and features will be in part apparent and in part pointed out hereinafter.

### BRIEF DESCRIPTION OF THE DRAWINGS

FIG. 1 is a front elevational view of the preferred embodiment of a magazine vending machine of the present invention;

FIG. 2 is a right side pictorial view of a magazine vending mechanism of the preferred embodiment of the present invention;

FIG. 3 is a right side view in partial cross section of the magazine vending mechanism shown in FIG. 2 with the pusher plate in the forward most position;

FIG. 4 is a view similar to FIG. 3 with the pusher plate in the rear most position;

FIG. 5 is a partial cross sectional view of a front lower portion of the magazine vending mechanism of FIG. 4 showing the magazine dispensing mechanism;

FIG. 6 is a front elevational view of the magazine vending mechanism of FIG. 2 with the deflector plate removed;

FIG. 7 is a top plan view of the “push-push” type locking mechanism of the preferred embodiment of the present invention;

FIGS. 8a-c are side views in partial cross section of the locking mechanism of FIG. 7 showing the camming pin in various positions within the locking cam member;

FIG. 9 is a front elevational view of the locking mechanism of FIG. 7;

FIG. 10 is a partial cross sectional view of the support tray for a row of vending mechanisms and the locking mechanism therefore;

FIG. 11 is a view similar to FIG. 10 with the tray locking mechanism in a different position;

FIG. 12 is a view similar to FIG. 10 with the tray locking mechanism in yet another position; and

FIG. 13 is a left side pictorial view of a magazine vending mechanism of the preferred embodiment of the present invention;

Corresponding reference characters indicate corresponding parts throughout the drawings.

### DETAILED DESCRIPTION OF THE PREFERRED EMBODIMENT

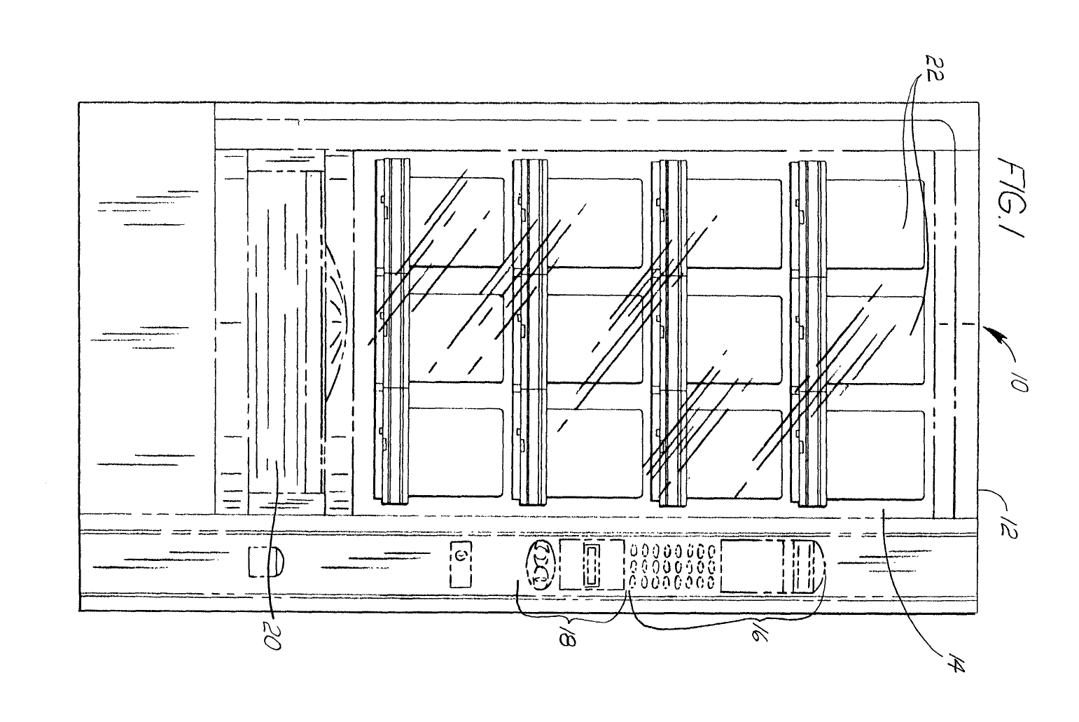

The vending machine 10, shown somewhat schematically in FIG. 1, is provided with some conventional features of vending machines which includes the cabinet 12 having a glass front 14, a product selection area 16 along the side of the machine and a monetary section 18 which allows a customer to establish credit in the machine for making a purchase. In addition, a vend bucket 20 is disposed in the lower front portion of the machine for allowing a customer to retrieve his or her purchase after the product has been vended from the shelves of the machine. Although the preferred embodiment will be described as a magazine vending machine it is intended that other similar articles can also be vended therefrom.

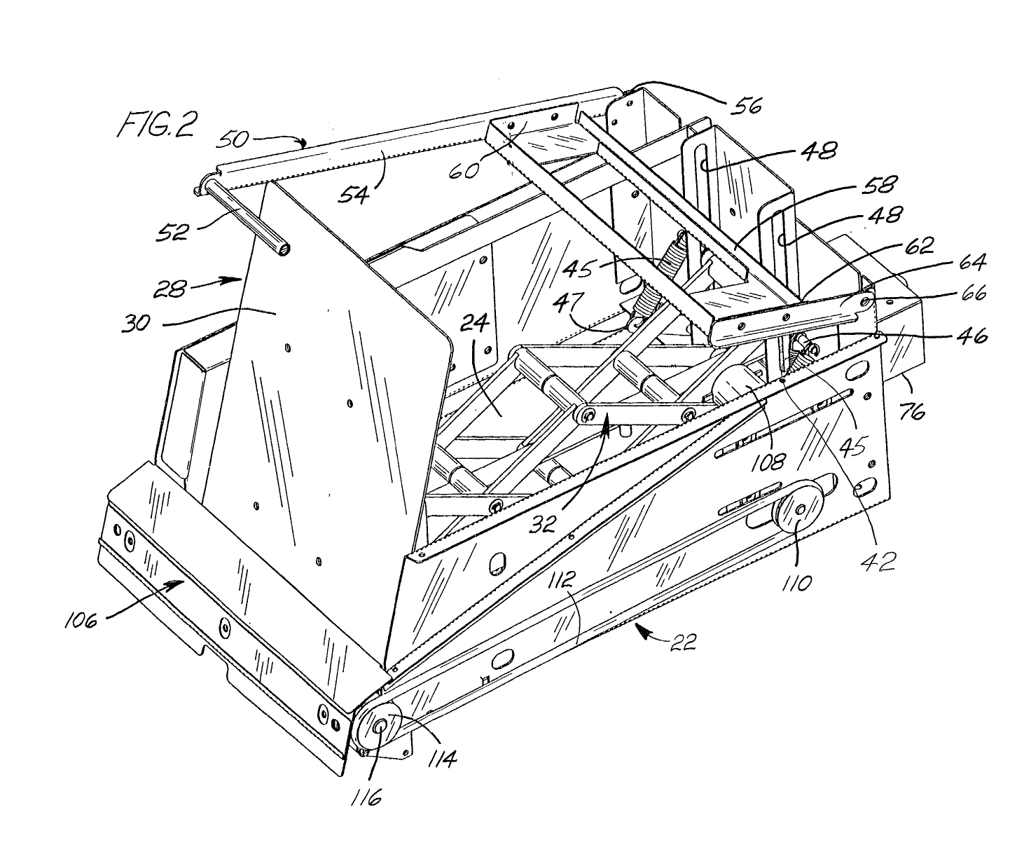

Contained within the vending machine 10 are unique magazine vending mechanisms 22, shown in FIG. 1, and shown in individual detail in FIGS. 2 through 6. Generally, these magazine vending mechanisms 22 are mounted in a series of columns and rows within the machine, such as illustrated in FIG. 1, which each present a magazine for viewing by a potential customer through the glass front 14. In the embodiment shown, each row of three magazine vending mechanisms 22 are mounted on slide out shelves which permit easy loading of the mechanisms 22 with a fresh supply of magazines.

As best illustrated in FIGS. 2 through 6, each magazine vending mechanism module 22 is provided with a magazine support surface 24 which extends substantially the length of the bottom of mechanism 22 and supports a stack of magazines on their bottom edges as they are slid forward and dispensed from the mechanism. The support surface 24 also extends substantially across the width of the mechanism 22 and there is a central channel 26 which extends the length of the support surface in which part of the dispensing mechanism moves as described in detail below. Thus, magazines are supported along a substantial portion of their bottom edge by support surface 24 except through the central region where the channel 26 is formed.

The magazine vending mechanism 22 also includes a pusher plate assembly, shown generally as 28, which urges a stack of magazines towards the front of the magazine vending mechanism 22 for their dispensing. The assembly 28 includes a pusher plate 30 which is slanted slightly towards the rear of the vending mechanism 22 to aid in the presentation of the magazine through the transparent glass front 14. Pusher plate 30 is mounted to a scissor-type mechanism 32 for movement between a rearmost position wherein the maximum capacity of magazines can be inserted, and a foremost position in which the magazine vending mechanism 22 has been emptied of magazines. The scissor-type mechanism 32 is comprised of a series of arms 34 pivotally interconnected at various pivot points so as to expand and contract in length when the pusher plate 30 moves between its rearmost and foremost positions. Pusher plate 30 is mounted through a support frame 38 to the bottom forward most pivot point 35 on the scissor-type mechanism 32, which also carries a pair of wheels 40 which are spaced apart and ride within the channel 26 in support surface 24. This supports the pusher plate for its movement between its rearmost and foremost positions as the scissor-type mechanism 32 expands and contracts accordingly.

In order to bias the pusher plate 30 toward its foremost position, two sets of springs are provided near the rear of the magazine vending mechanism 22. A first set of springs 42 have one hooked or looped end of each mounted for independent rotation on a pivoting rod 43 rotatably mounted to the main body of the magazine vending mechanism 22 and secured to the rear set of arms 34 for rotation therewith. The opposite ends of each spring 42 are independently rotatably supported by a rod 46 which also forms the pivot point 36 of the upper rearmost portion of the scissor-type mechanism 32, and which moves in a pair of slots 48 formed in a rear portion of the main body of magazine vending mechanism 22. A second set of springs 45 each have an end hooked to an arm 47 mounted to rod 43 for rotation therewith and an opposite end hooked for freedom of rotation to rod 46. Thus, the force of springs 42 constantly tend to draw the rearmost pivot points 36 towards each other so as to extend the scissor-type mechanism 32 and thus urge the pusher plate 30 from its rearmost to its foremost position. As the pusher plate 30 moves closer to the rear most position the arms 47 are rotated upward and the springs 45 are extended to add additional biasing force to the scissor-type mechanism so that the increased load of the additional magazines when the vending mechanism is substantially full can be moved forward toward the dispensing mechanism.

A magazine retention assembly, shown generally as 50, is provided to maintain the magazines in an upright position with their backs against pusher plate 30 so that as they are moved forward they do not collapse and fall over the front of the magazine vending mechanism 22. The magazine retention assembly 50 includes a magazine retention member in the form of a roller 52 which engages the upper front cover of the foremost magazine positioned in the magazine vending mechanism 22 to thus prevent its falling forward. The magazine retention member 52 is mounted at one end to a support arm 54 which is pivotally mounted at its opposite end 56 to the main body of the magazine vending mechanism 22. For stability and strength, a cross-member 58 is mounted at one end 60 to support arm 54 and at an opposite end 62 to a second pivotally mounted arm 64, which is also mounted to the main body of the magazine vending mechanism 22 at 66.

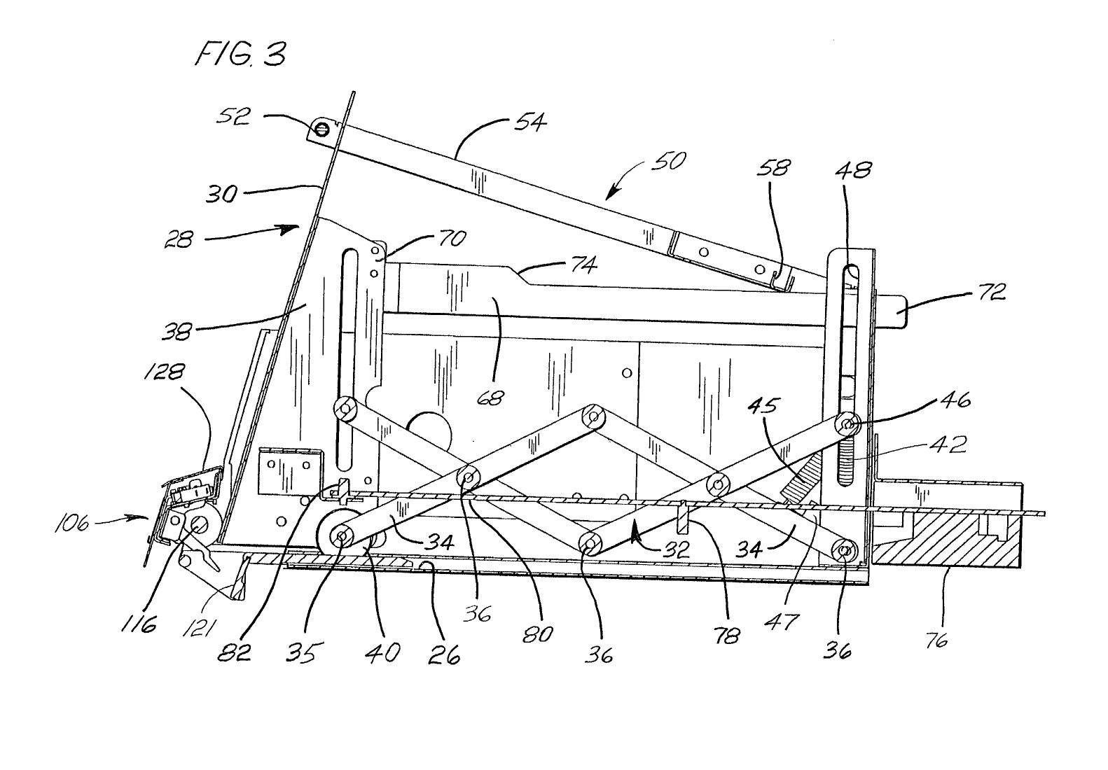

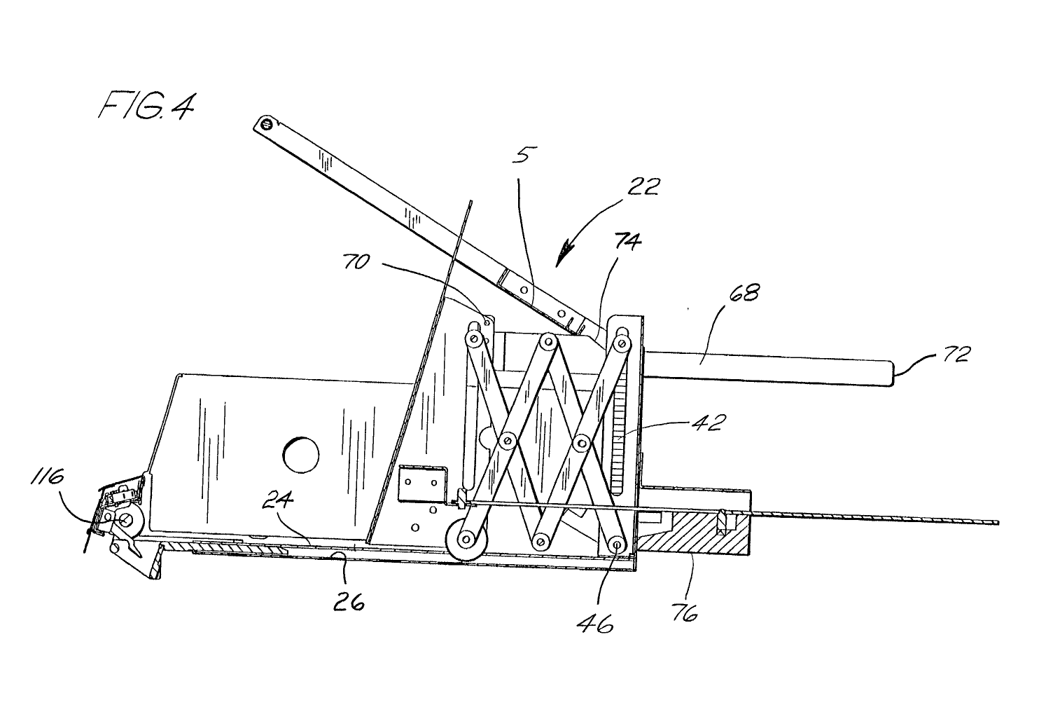

As best seen in FIG. 3, a camming bar 68 is mounted to an upper portion of the frame member 38 at one end 70 and the opposite end 72 rides in a slot formed in the rear portion of the housing for the vending mechanism 22 so that as the pusher plate 30 is moved toward its rearmost position the camming bar 68 moves rearwardly and extends out of the slot formed in the rear portion of the magazine vending mechanism 22. As the camming bar 68 approaches its rearmost location where the pusher plate is at its rearmost location, as seen in FIG. 4, a camming surface 74 engages a portion of the cross-member 58 which causes the support arm 54 to be pushed upwardly to a position above the path of the pusher plate so as to allow a new stack of magazines to be easily inserted into the magazine vending mechanism 22. As the pusher plate 30 is moved forward after magazines have been loaded, the camming surface 74 pulls forward of the cross-member 58 allowing the support arm 54 and retention member 52 to fall by gravity so that the retention member is placed in the upper front portion of a magazine positioned in the dispensing mechanism to thus prevent it from falling forward as the magazines are dispensed.

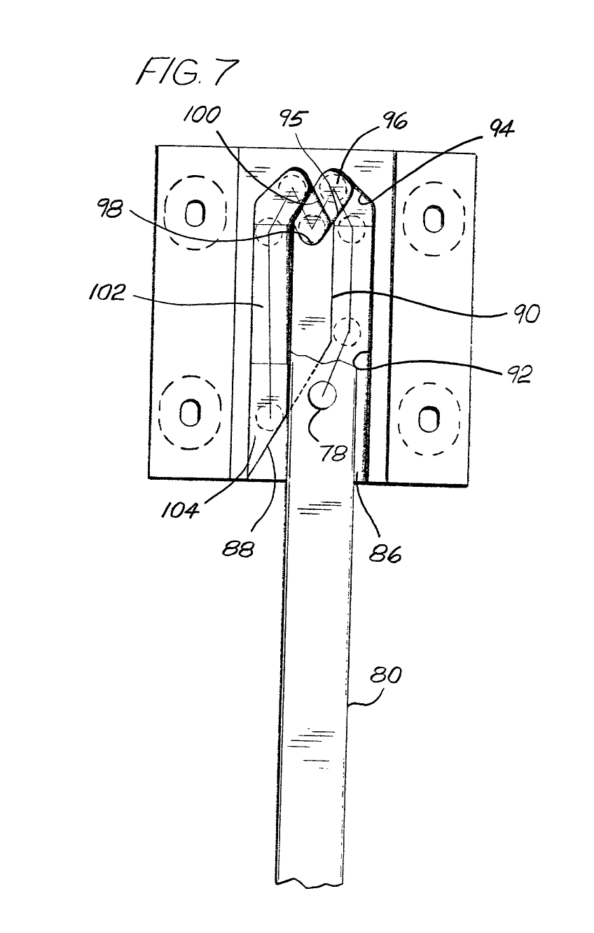

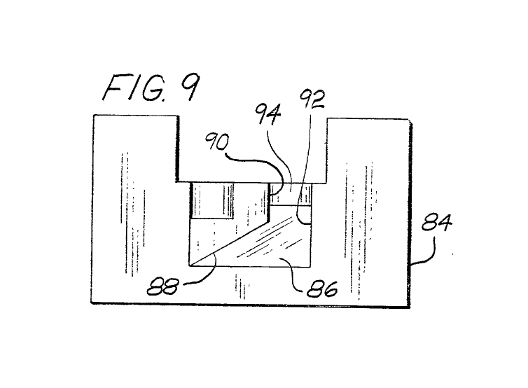

In order to make the loading of magazines simpler when the pusher plate 30 is pushed to its rearmost position, so that the operator doesn't need to hold the pusher plate in that position while loading magazines, a locking mechanism, shown generally as 76, is mounted to the rear of the main body of magazine vending mechanism 22, as best seen in FIGS. 2 through 4. Locking mechanism 76 incorporates a well known general type locking mechanism typically utilized in cabinet doors and the like and is generally called a “push-push” type mechanism which requires the operator to make an initial push on the door to cause the door to lock in a certain position and then upon a subsequent push the lock is released and the door is allowed to be opened. In the present application, the use of the “push-push” type mechanism allows an operator to push rearwardly on pusher plate 30 to where it is engaged with locking mechanism 76. Then the operator releases the pusher plate 30 and it is held in a locked position until the operator loads the machine with magazines and then pushes again rearwardly on the stack of magazines which releases the locking mechanism 76 and allows the pusher plate 30 to push the magazines toward the front of the magazine vending mechanism 22. Locking mechanism 76 includes a plurality of cam surfaces formed in a locking cam member and which is engaged by a cam follower which is a pin 78 mounted on a push rod 80 which is pivotally mounted to the frame portion 38 supporting the pusher plate 30. Pivoting the push rod 80 on the pin 82 allows the cam follower pin 78 to maneuver through the camming surfaces in the locking mechanism 76 as described in detail below. Push rod 80 extends a sufficient distance through the rear of the magazine vending mechanism 22 to stay in engagement with the locking mechanism 76 when the push plate 30 is in its forward most position and is allowed to extend out of the back of the locking mechanism 76 when the push plate 30 is in its rearmost position. The locking mechanism 76 and its operation will be described more specifically in a conjunction with FIGS. 7 through 9.

Generally, this “push-push” locking mechanism preferably includes a cam follower connected to the push rod and having a cam engaging portion; a locking cam member having an inlet and an outlet on a front side thereof and camming grooves in a top surface thereof having a generally heart-shaped configuration stepped at different levels from the inlet to the outlet so as to provide a one-way path for the cam follower through the cam member. This path includes an intermediate locking position. The inlet of the locking member also preferably includes side walls which channel the cam follower into the camming grooves, the camming grooves including an upwardly inclined ramp extending from the inlet to a remote end terminating in a first step below the end of the ramp and extending in a direction away from the inlet, a second step extending downwardly from the first step in a direction toward the outlet and forming a locking position in which the cam follower will remain unless the spring force is overcome, a third step extending downwardly from the second step in a direction away from the inlet and a fourth step extending toward the outlet including an upwardly inclined portion terminating in the outlet.

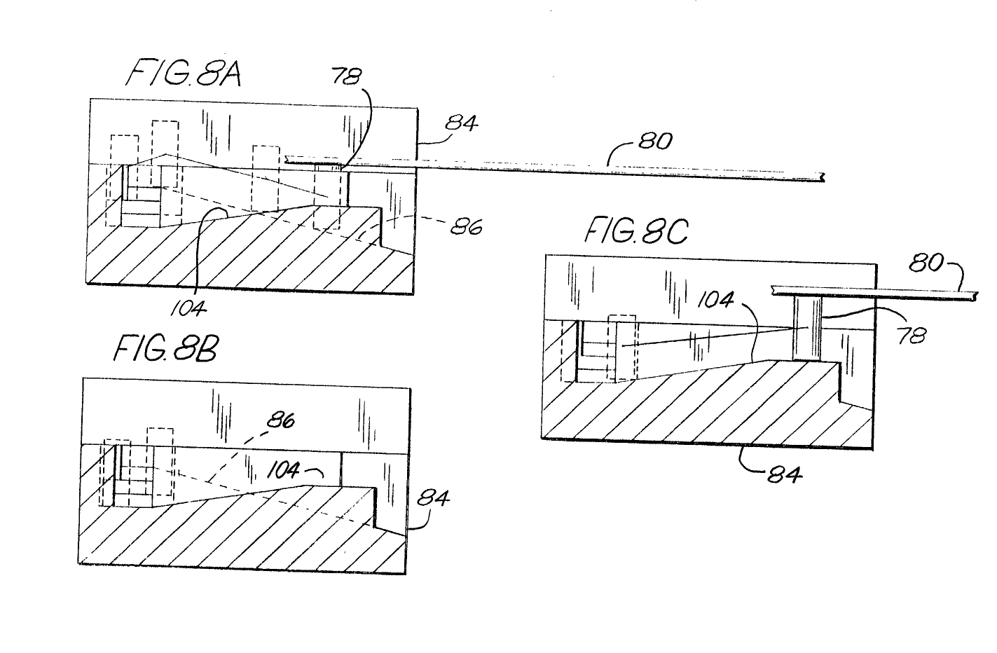

More specifically, the locking mechanism 76 will lock the pusher plate 30 in the rear position and will release the pusher plate 30 for forward movement of the pusher plate 30 to move the magazines in position for dispensing. The device includes the pusher rod 80 and the depending cam follower pin 78. A locking cam member in the form of a camming latch block 84 has a series of camming surfaces and grooves to guide the pin 78 from an entry position (FIG. 8A) to a locked position (FIG. 8B) and a released position (FIG. 8C). The pin 78 first moves up a ramp 86 guided by inclined wall 88 and then side walls 90 and 92. At the top of the ramp 86, a cam surface 94 forces the pin 78 to move to the left where the pin 78 falls into a pocket 96. Forward movement of the pin 78 causes it to move more to the left by cam surface 95. Further forward movement (forward under bias of the pusher plate springs) moves the pin 78 into a vertical detent 98 to prevent further forward motion (this is the locked position when the magazines would be loaded). When moving into the locked position, the pin moves downwardly another level.

After loading, the pin 78 is moved rearward by an operator and is forced to move again to the left by the cam surface 100 with the pin dropping still another level. Release of the pusher bar will allow the pin (and also the rod 80 and pusher plate 30) to move forward in the groove 102 and up a second ramp 104 under bias of the pusher plate springs 42, to thereby move the magazines forward for dispensing. The ramp 104 provides a forward portion of the wall 88 which prevents the pin from accidently entering the groove 102 during rearward movement of the pin 78. Thus, a simple locking mechanism 76 is provided.

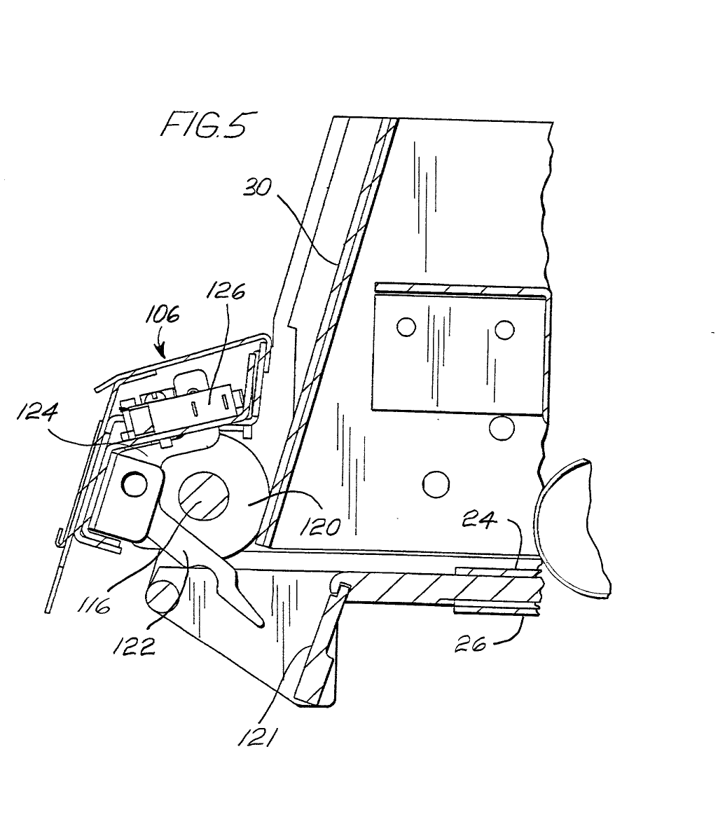

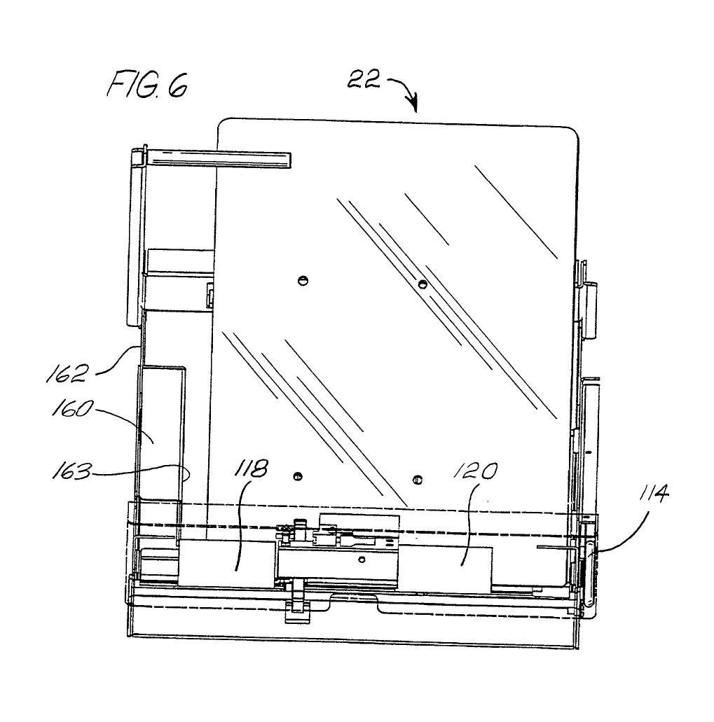

Secured to the lower front edge of the magazine vending mechanism 22 is a magazine dispensing mechanism 106, as best seen in FIGS. 2 through 6. This magazine dispensing mechanism 106 dispenses the forward most magazine from the magazine vending mechanism 22 in response to a selection by a customer. The magazine dispensing mechanism 106 is motor driven in response to customer selection. In the preferred embodiment, a motor 108 is mounted in the rear portion of the main body of magazine vending mechanism 22, as shown in FIG. 2, and drives a first pulley wheel 110 through a gear reduction mechanism (not shown), which in turn drives an endless belt 112 extending towards the front side edge of the main body of the magazine vending mechanism 22 and around a driven pulley 114. The pulley 114 is, in turn, secured for rotation to drive shaft 116 which is mounted in and extends across the forward lower edge of magazine vending mechanism 22. As best seen in FIGS. 5 and 6, a pair of magazine vending rollers 118 and 120 are secured to drive shaft 116 for rotation therewith and engage the outer surface of the magazine at the lower front edge thereof and when rotated, feed the magazine down through the opening between rollers 118 and 120 and an adjustable magazine thickness gauge 121. Gauge 121 is disposed at the front edge of the magazine support surface and is slidably supported beneath the surface for movement toward and away from the magazine dispensing mechanism 106 so as to engage the back cover of a magazine when the front cover is engaged by the dispensing mechanism, the gauge 121 prevents a second magazine adjacent the magazine being dispensed from also being dispensed and also acts to direct the magazine being dispensed into the opening between the glass and the fronts of the magazine vending mechanisms 22 so as to avoid getting hung-up on the magazines in a lower vending mechanism 22.

A magazine position sensing lever 122 is pivotally mounted to a front wall of the magazine dispensing mechanism 106 and has an upper arm 124 which engages a microswitch 126 when in its rest position, as shown in FIG. 5. The lever 122 is biased to this rest position by a spring (not shown). When a magazine is dispensed from between the rollers 118 and 120 and a stack of magazines, or the final magazine disposed against pusher plate 30, it will engage the outer tip of the sensing lever 122 causing the upper arm 124 to move toward and activate the microswitch thus indicating the beginning of dispensing of a magazine. As the magazine is dispensed, its upper edge of the front cover will pass the lever 122 freeing the lever and allowing the upper arm 124 to disengage from the microswitch 126 thus indicating the magazine has been dispensed from the magazine dispensing mechanism 106 and the magazine vending mechanism 22. These movements of the microswitch 126 and the signal that it sends to a microprocessor mounted within the cabinet of the magazine vending machine are utilized to adjust the movements of the magazine dispensing mechanism 106 so as to adjust for varying heights of a magazine being dispensed as described in detail below.

The magazine vending machine uses a two-stage motor operation of motor 108 to deliver a magazine. A first stage runs the motor continuously for the majority of the magazine dispense duration. A second stage turns the motor on and off to achieve a pulsing or ratcheting action near the end of a magazine feed cycle. Since magazines vary in thickness, weight, surface texture and binding, fixed motor timing on the delivery system would not work well. An automatic timing adjustment is therefore desirable which modifies the duration of the first stage of operation of motor 108 to achieve an optimum delivery method. This method will deliver the magazine in the shortest time possible by running the motor 108 continuously as long as possible and then pulsing motor 108 to achieve a single magazine drop without a second magazine following into the rollers 118 and 120.

For example, the motor 108 is run continuously at normal speed for most of the magazine dispensing period. During approximately the last 1″ of the magazine travel, the motor 108 is turned on and off creating a pulsing action. The pulsing motor runs slower (e.g., at 1/2 the normal speed of motor 108). The duration of the continuous motor run is adjusted to try and maintain a pulsing action which lasts for a short fixed amount. The total duration of the pulsing action is timed. The duration of the continuous run time is not timed. If the pulsing lasts longer than desired, then the continuous run time is increased. If the pulsing duration was too short, continuous run time is reduced. The pulsing action will continue until the magazine drops or a long period of time has elapsed which indicates a problem.

The pulsing or ratcheting action helps to drop the first magazine and hinders the second magazine from following the first through the dispensing mechanism 106.

When the product identification of the magazine is changed in the microprocessor by a service person, it indicates to the microprocessor that the magazine has been changed. This indication of a new magazine causes the continuous run time value to be set to the default value in the microprocessor. The continuous run time value controls how long the motor 108 runs at full speed. The continuous run time value is the value that is adjusted to optimize the magazine drop. The continuous run time is set to a value that is shorter than required for any magazine.

When pulsing duration is shorter than desired the continuous run time is decreased. Thus, if the pulsing action was less than the desired time period, then the continuous run time will be decreased in order to increase the pulsing action on future vends. The continuous run time is preferably reduced at a fairly high rate to always ensure that there will be a good amount of pulsing action. The continuous run time is reduced at a higher rate than it is increased to ensure that the pulse action will be present.

When pulsing duration is longer than desired the continuous run time is decreased. If the pulsing action was greater than the desired time period, the continuous run time will be increased in order to decrease the pulsing action on future vends. The continuous run time is increased at a small rate to always ensure the second stage pulsing is not shortened too much. It is preferable to always have the pulsing action present.

When a very long duration of pulsing occurs to dispense a magazine, a pulsing duration that is greater than normal values expected, additional reduction factors are applied before adjusting the continuous run time. For example, when a magazine is not grabbed immediately the rollers 118 and 120 can turn for several seconds before catching the magazine and starting the dispensing cycle. The dispense will be completed but the pulsing duration will be longer than normal to accomplish. This extra long pulse duration is weighed less than smaller values.

When a new magazine is installed in the machine, the first adjustment of continuous run time is allowed a larger adjustment to get the continuous run time very close to the final value on the first pass. Additional adjustments are made at a smaller rate.

The motor timers in the microprocessor are not adjusted for the following conditions:

1. While in the motor test mode, this is because the motor test mode is used to do non-standard dispense actions. For example, the motor 108 is turned on and dispensing mechanism rollers 118 and 120 are cleaned in this mode. The microswitch 126 senses the magazine drop is triggered by hand in this mode, not by an actual magazine drop.

2. The timers will not be updated if the proceeding vend did not reach a normal completion. The motor 108 may have jammed and not dispensed a magazine or a trailing magazine followed the first into the dispense rollers 118 and 120. In the latter case, the machine is timed out and the second magazine will not actually be dispensed but is likely stuck in the dispensing path.

Since a plurality of magazine vending mechanisms 22 are stacked one above another, such as four rows as illustrated in FIG. 1, it is possible for magazines vended from the upper mechanisms 22 to become stuck in one of the vending mechanisms immediately below it and thus not actually get into the vend bucket 20 as desired. To prevent this, a magazine deflection plate 128 is provided as a cover above each of the magazine dispensing mechanism 106. This magazine deflection plate 128 is impacted by the bottom edge of a magazine vended from a magazine vending mechanism 22 disposed above it so that it is propelled forward towards the opening between the rear of the glass front 14 and the front edges of the rows of magazine vending mechanisms 22 and thus reliably dispensed into the vend bucket 20.

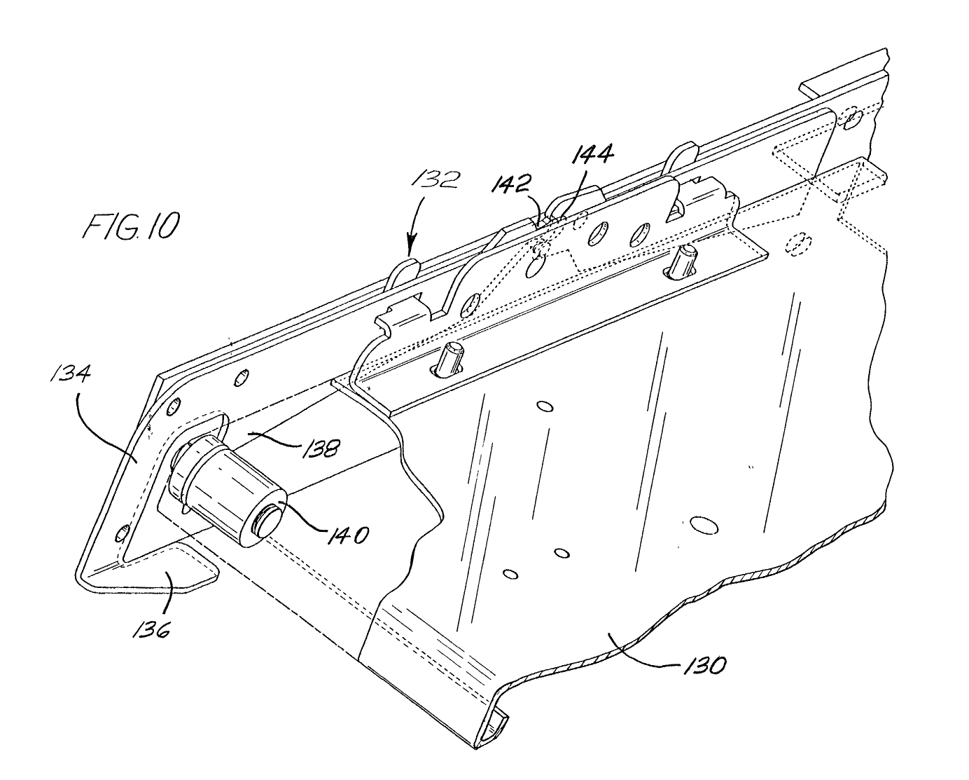

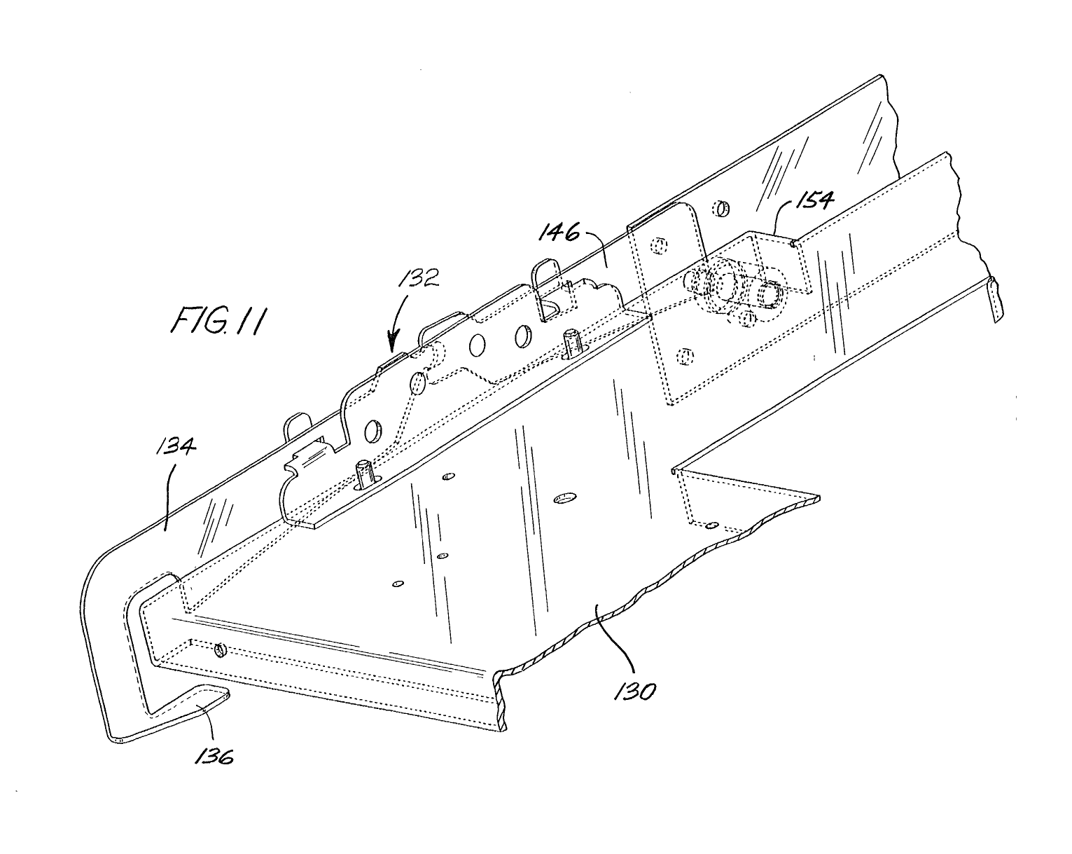

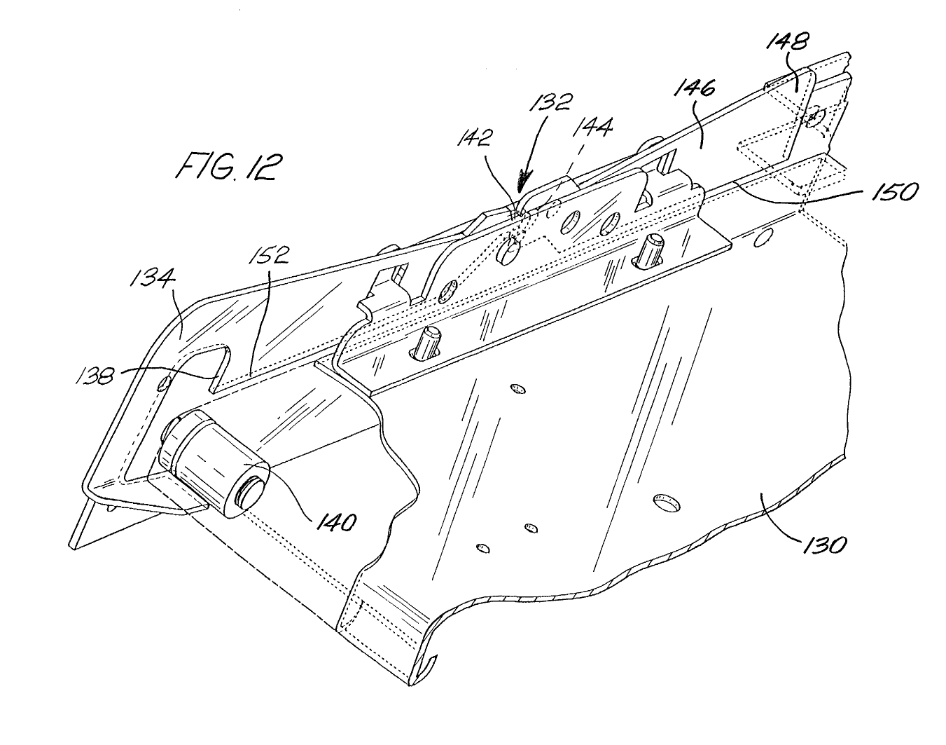

Each row of magazine vending mechanisms 22 is mounted to a single slide out tray 130, as best seen in FIGS. 10 through 12, which are each provided with a locking mechanism, shown generally at 132, for assisting in loading the magazine vending mechanisms 22. As seen in FIG. 10, the tray is shown in its locked position within the cabinet where the magazine vending mechanisms 22 are normally positioned for operation. The tray locking mechanism 132 includes a manual lift lever 134 which the operator pushes up on at 136 to lift the locking pawl 138 from behind the roller 140 on which the tray 130 glides forward. The operator can then pull the tray 130 outward to load the magazine vending mechanisms 22. As shown in FIG. 12, when the manual lift lever 134 is lifted its rearmost end has a camming surface 142 which is received in a correspondingly curved slot 144 formed in a cooperating linkage member 146 such that as the lift lever 134 is lifted it causes a rear end portion 148 of linkage member 146 to also be lifted sufficiently far that its lower edge 150 will pass over the roller 140 as tray 130 is moved out of the cabinet. In fact, once movement of tray 130 has begun the operator can let go of the manual lift lever 134 and the lower edge 152 thereof as well as the lower edge 150 of linkage member 146 will ride along the roller 140 as the tray is withdrawn from the cabinet. As shown in FIG. 11, once the tray has been withdrawn to a stopping point which is established by a down turned portion 154 of tray 130 which engages the backside of roller 140 to stop the outward movement of the tray. At the same time that 154 engages the rear portion of the roller 140 the rear edge of the linking member 146 drops in front of roller 140 so that the tray is prevented from being moved in either direction. After the magazine vending mechanisms 22 have been loaded by the operator, the operator again lifts lever 134 at lift point 136 and begins pushing the tray rearward so that the bottom edge 150 of linkage member 146 again rides on the top of roller 140 as the tray 130 is being returned to its operating position within the cabinet 10. When tray 130 reaches its rearmost position operating lever 134 drops to capture roller 140 and thus prevent any movement of the tray 130 until the manual lift lever 134 is again raised. This assembly provides an easy and reliable means of allowing the trays to be pulled out for loading the vending mechanisms 22 and then returning them to their operational positions.

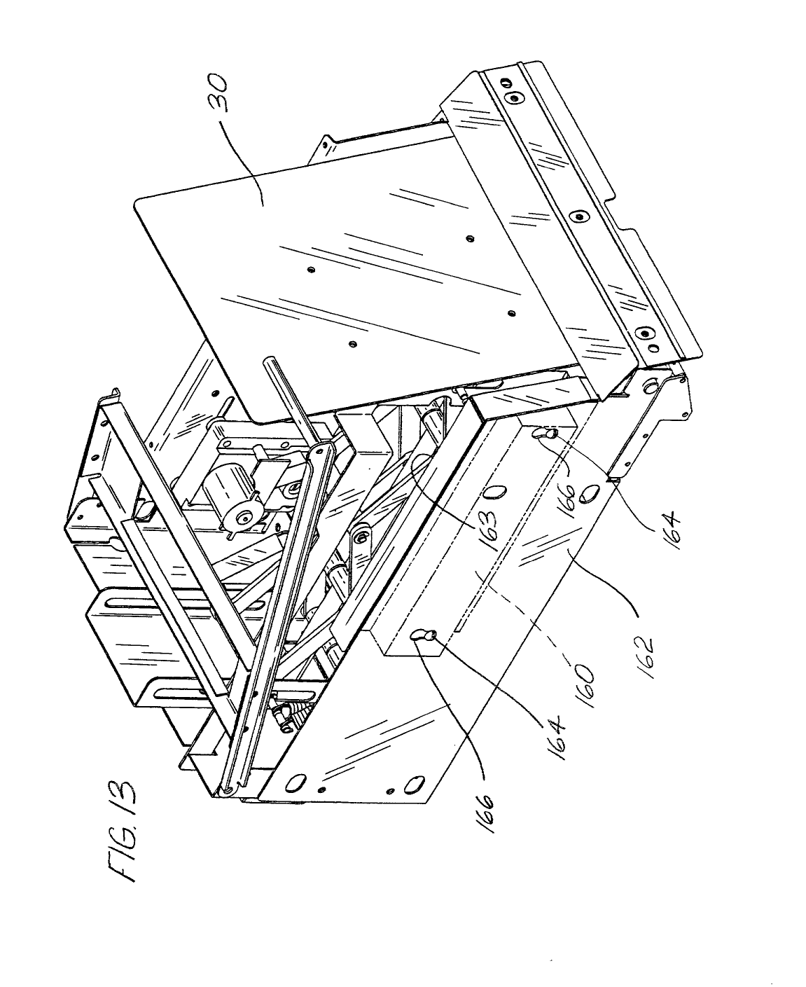

Since the width of different magazines varies, provision has been made for adjusting the internal width of a magazine vending mechanism 22 to compensate so that a stack of magazines are kept in alignment as they are loaded and vended. As best seen in FIGS. 6 and 13, a side spacer 160 is removably secured to the inside of a side panel 162 of a magazine vending mechanism 22. The spacer has an inner vertical surface 163 adjacent the pusher plate for engaging one edge of the stack of magazines to keep them generally aligned. The spacer 160 can be made in different widths to accommodate different widths of magazines. The spacer 160 is easily inserted and removed from the magazine vending mechanism 22. It is provided with a pair of screws or rivets 164 or the like, who's heads are slideably received in key-shaped slots 166 to position the spacer adjacent the pusher plate 30 and secured to the wall 162.

In view of the above, it will be seen that the several objects of the invention are achieved and other advantageous results attained.

As various changes could be made in the above constructions, without departing from the scope of the invention, it is intended that all matter contained in the above description and shown in the accompanying drawings shall be interpreted as illustrative and not in a limiting sense.

What is claimed is:

1. A magazine vending machine, comprising:
a cabinet having a substantial portion of a front panel thereof transparent;
a monetary section for establishing credit in the machine;
a selection panel for allowing a customer to make a selection of a magazine from the machine once adequate credit is established;
a plurality of magazine vending mechanisms mounted within the cabinet and viewable through the transparent portion of the front panel;
each vending mechanism including a magazine support surface engageable by an edge of a magazine so as to support the magazine to be vended from the vending mechanism; a pusher plate movable between a position adjacent the transparent portion of the front panel and a position remote from the transparent portion of the front panel and engageable with a back cover of the magazine so as to move the magazine along the support surface; a magazine dispensing mechanism disposed at a front edge of the magazine support surface and having at least one motor driven friction wheel engageable with a front cover of a magazine disposed at the front edge of the magazine support surface for vending a magazine from the vending mechanism; and
a vend bucket mounted within the cabinet beneath the plurality of magazine vending mechanisms so as to receive a magazine vended from any of the magazine vending mechanisms and accessible by a customer to remove the vended magazine.

2. A magazine vending machine as claimed in claim 1 including a mechanism engaging the pusher plate for biasing the pusher plate toward the front panel.

3. A magazine vending machine as claimed in claim 2 wherein the mechanism engaging the pusher plate includes a scissor mechanism engaging the pusher plate and biased by a spring so as to bias the movement of the pusher plate toward the front panel.

4. A magazine vending machine as claimed in claim 1 wherein the pusher plate is tilted rearwardly from vertical so as to display a magazine engaged by the pusher plate at a rearward angle from the vertical.

5. A magazine vending machine as claimed in claim 1 including a magazine retention member disposed above the front edge of the magazine support surface and engageable with an upper portion of the front cover of a magazine when disposed at the front edge of the support surface.

6. A magazine vending machine as claimed in claim 5 wherein the magazine retention member is mounted to the magazine vending mechanism for movement between a first position where it will engage the front cover of a magazine disposed at the front edge of the support surface and a second position remote therefrom such that a magazine can be loaded into the vending mechanism without engaging the retention member.

7. A magazine vending machine as claimed in claim 6 wherein the retention member is pivotally mounted to a rear portion of the vending mechanism so as to be movable between the first and second positions.

8. A magazine vending machine as claimed in claim 7 including a member mounted to the pusher plate and engageable with the retention member when the pusher plate is moved toward its position remote from the front panel so as to move the retention member to its second position.

9. A magazine vending machine as claimed in claim 1 including a locking mechanism associated with the pusher plate for releasably holding the pusher plate in the position remote from the front panel.

10. A magazine vending machine as claimed in claim 9 including a push rod connected at one end to the pusher plate and an opposite end engageable with the locking mechanism; the locking mechanism including a “push-push” type locking mechanism.

11. A magazine vending machine as claimed in claim 1 wherein the locking mechanism includes:
a cam follower connected to the push rod and having a cam engaging portion;
a locking cam member having an inlet and an outlet on a front side thereof and camming grooves in a top surface thereof having a generally heart-shaped configuration stepped at different levels from the inlet to the outlet so as to provide a one-way path for the cam follower through the cam member, including an intermediate locking position; and
a spring member urging the cam follower in a direction out of the inlet and outlet of the locking member.

12. A magazine vending machine as claimed in claim 11 wherein the inlet of the locking member includes side walls which channel the cam follower into the camming grooves, the camming grooves including an upwardly inclined ramp extending from the inlet to a remote end terminating in a first step below the end of the ramp and extending in a direction away from the inlet, a second step extending downwardly from the first step in a direction toward the outlet and forming a locking position in which the cam follower will remain unless the spring force is overcome, a third step extending downwardly from the second step in a direction away from the inlet and a fourth step extending toward the outlet including an upwardly inclined portion terminating in the outlet.

13. A magazine vending machine as claimed in claim 1 wherein the magazine dispensing mechanism includes:
the motor being mounted in a rear portion of the magazine dispensing mechanism;
the friction wheel being mounted on a rotatable shaft mounted in the front portion of the vending mechanism; and
an endless belt driven by the motor and engaging the shaft for rotating the friction wheel.

14. A magazine vending machine as claimed in claim 1 wherein the magazine dispensing mechanism includes:
a. a lever and microswitch arrangement such that the lever is engageable with the front cover of a magazine for sensing when the upper edge of a magazine being dispensed passes the lever;
b. means associated with the motor for operating the motor to rotate the friction wheel in response to a vend signal initiated by a customer to feed a magazine off of the front edge of the magazine support surface, the means including continuously running the motor for the majority of the dispensing cycle and then stepping the motor in small increments near the top of the magazine until the microswitch indicates that the top of the magazine has passed the lever and then stopping the motor and maintaining in a memory the height of the magazine so that the next operation steps the motor for a lesser number of steps nearer the top of the magazine.

15. A magazine vending machine as claimed in claim 1 including an adjustable magazine thickness gauge disposed at the front edge of the magazine support surface and slideably supported beneath the surface for movement toward and away from the magazine dispensing mechanism so as to engage the back cover of a magazine when the front cover is engaged by the dispensing mechanism, the gauge preventing a second magazine adjacent the magazine being dispensed from also being dispensed.

16. A magazine vending machine as claimed in claim 1 including a magazine deflector plate disposed at the front of a first magazine dispensing mechanism so as to deflect a magazine dispensed from a second magazine dispensing mechanism disposed above the first magazine dispensing mechanism.

17. A magazine vending machine as claimed in claim 1 wherein a plurality of magazine dispensing mechanisms are mounted to a tray movably mounted within the cabinet for movement between an operating position in the cabinet and a loading position substantially out of the cabinet.

18. A magazine vending machine as claimed in claim 17 wherein a magazine tray locking mechanism is provided for releasably retaining the tray in its operating position and in its loading position.
